(19) United States
(12) Patent Application Publication
(10) Pub. No.: US 2011/0316825 A1
(43) Pub. Date: Dec. 29, 2011

(54) ORGANIC ELECTROLUMINESCENCE DISPLAY

(75) Inventors: Sang Hyun CHA, Gyeonggi-do (KR); Youn Joong LEE, Seoul (KR); Jae Shin LEE, Gyeonggi-do (KR)

(73) Assignee: SAMSUNG ELECTRO-MECHANICS CO., LTD.

(21) Appl. No.: 12/917,230

(22) Filed: Nov. 1, 2010

(30) Foreign Application Priority Data
Jun. 24, 2010 (KR) 10-2010-0060071

(51) Int. Cl. G09G 5/00; G09G 3/30

(52) U.S. Cl. 345/205; 345/76

(57) ABSTRACT

Disclosed herein is an organic electroluminescence display. The organic electroluminescence display includes: a plurality of pixels arranged in a matrix format on a display panel and configured of first to N+K-th rows; a plurality of first data lines connected to pixels each in the same column of pixels in the first to N-th rows; a plurality of second data lines connected to pixels each in the same column of pixels in the k+1-th to N+K-th rows; and a plurality of pixel driving buffers sensing time constants of the second data lines and compensating for data currents according to the number of sensed time constants to drive the respective corresponding first data lines with the compensated data currents. The organic electroluminescence display can reduce operation deviation between the pixels according to parasitic components of the data lines.

### CROSS REFERENCE TO RELATED APPLICATION

This application claims the benefit of Korean Patent Application No. 10-2010-0060071, filed on Jun. 24, 2010, entitled “Organic Electroluminescence Display”, which is hereby incorporated by reference in its entirety into this application.

### BACKGROUND OF THE INVENTION

1. Technical Field

The present invention relates to an organic electroluminescence display, and more particularly, to an organic electroluminescence display that ensures operation unity of pixels by previously compensating for data current delayed and attenuated according to parasitic components of each of the data lines.

2. Description of the Related Art

Recently, the importance of a flat panel display (FPD) has further increased with the development of multimedia. As a flat panel display, there are a liquid crystal display, a plasma display panel (PDP), an organic electroluminescence display, and the like.

Among others, the organic electroluminescence display is a device that forms organic light emitting diodes (OLEDs), that are fluorescent organic compounds, on a substrate and electrically excites and emits them. The organic electroluminescence display is advantageous in view of a low power consumption, high response velocity, a high emission efficiency, a large viewing angle, and the like, such that it has been widely used in recent years.

Generally, an organic electroluminescence display includes a display panel on which pixels are arranged in a matrix format, and a gate driver and a data driver for driving the pixels. Among others, the gate driver activates the pixels in a row unit and the data driver applies data signals to the pixels activated through data lines.

Meanwhile, each of the data lines has parasitic resistance and parasitic capacitance, such that it may delay a transmission time when transmitting the data signals, thereby causing degradation in operation velocity. In addition, the parasitic resistance and the parasitic capacitance are different between the data lines, such that the transmission time of the data signals for each pixel may be different due to such a difference, thereby causing degradation in operation unity of the pixels. In particular, the length of the data lines becomes long as a display panel becomes large, such that the parasitic resistance and the parasitic capacitance are also increased. Therefore, operation deviation between the pixels may further be increased.

### SUMMARY OF THE INVENTION

An object of the present invention is to provide a unit capable of preventing operation deviation that may be generated between pixels by previously compensating for delay and attenuation of data currents according to parasitic components of respective data lines.

According to an exemplary embodiment of the present invention, there is provided an organic electroluminescence display, including: a plurality of pixels arranged in a matrix format on a display panel; a plurality of first and second data lines repeatedly arranged in a column direction on the display panel, while forming a pair; and a plurality of pixel driving buffers sensing time constants of the respective second data lines and compensating for each of data currents by the number of sensed time constants to drive pixels connected to the corresponding first data lines with the compensated data currents.

According to an exemplary embodiment of the present invention, there is provided an organic electroluminescence display, including: a display panel; a plurality of pixels arranged in a matrix format on the display panel; a gate driver sequentially activating the pixels in a row unit through gate lines connected to each of the pixels in the row unit; a data driver outputting data current in order to drive the pixels in the activated row; a plurality of data lines arranged in a column direction on the display panel, each being connected to the pixels in a column unit; a plurality of dummy data lines arranged corresponding to the respective data lines; and a plurality of pixel driving buffers sensing time constants of the respective dummy data lines and compensating for each of data currents according to the number of sensed time constants to drive the pixels through the corresponding data lines.

According to an exemplary embodiment of the present invention, there is provided an organic electroluminescence display, including: a plurality of pixels arranged in a matrix format on a display panel and configured of first to N+k-th rows; a plurality of first data lines connected to pixels each in the same column of pixels in the first to N-th rows; a plurality of second data lines connected to pixels each in the same column of pixels in the k+1-th to N+K-th rows; and a plurality of pixel driving buffers sensing time constants of the second data lines and compensating for data currents according to the number of sensed time constants to drive the respective corresponding first data lines with the compensated data currents.

According to an exemplary embodiment of the present invention, there is provided an organic electroluminescence display, including: a display panel; a plurality of data lines and gate lines arranged on the display panel orthogonally to each other; a plurality of dummy data lines arranged in parallel, each corresponding to the data lines; a plurality of first pixels configuring at least one row and each connected to the data lines; a plurality of second pixels configuring at least one row and connected in common to the data lines and the dummy data lines; a plurality of third pixels configuring at least one row and each connected to the dummy data lines; and a plurality of pixel driving buffers sensing time constants of the respective dummy data lines and compensating for data currents according to the number of sensed time constants to drive pixels each connected to the corresponding data lines.

### BRIEF DESCRIPTION OF THE DRAWINGS

FIG. 1 is a block diagram showing a configuration of an organic electroluminescence display according to a first embodiment of the present invention; and

FIG. 2 is a block diagram showing a configuration of an organic electroluminescence display according to a second embodiment of the present invention; and

FIG. 3 is a block diagram showing a configuration of a pixel driving buffer.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, an organic electroluminescence display according to exemplary embodiments of the present invention will be described with reference to the accompanying drawings.

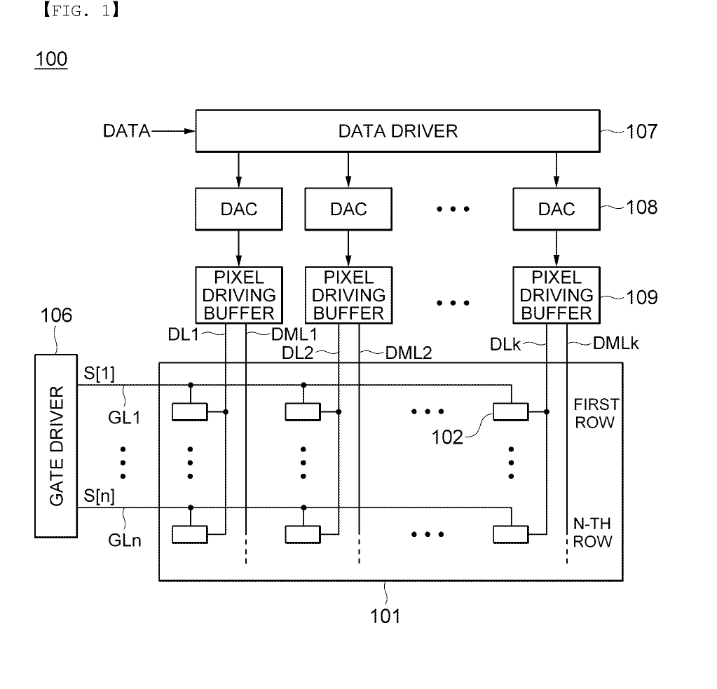

FIG. 1 is a block diagram showing a configuration of an organic electroluminescence display according to a first embodiment of the present invention.

Referring to FIG. 1, an organic electroluminescence display 100 includes a display panel 101, a gate driver 106, a data driver 107, a plurality of digital-analog converters (DAC) 108, and a plurality of pixel driving buffers 109.

Functions of each block of the organic electroluminescence display 100 constituted as described above will be described.

First, a plurality of pixels 102 are arranged in a matrix format on a display panel 101, wherein the respective pixels 102 are electrically connected to the gate driver 106 through gate lines GL1 to GLn and are electrically connected to the data driver 107 through data lines DL1 to DLk. Meanwhile, a plurality of dummy data lines DML1 to DMLk are arranged on the display panel 101, while being adjacent to each of the data lines DL1 to DLk. At this time, the pixels 102 in a column unit are electrically connected to the respective data lines DL1 to DLk, whereas the pixels 102 are not connected to the dummy data lines DML1 to DMLk. Herein, the reason why the dummy data lines DML1 to DMLk are arranged adjacent to the respective data lines DL1 to DLk is to measure the time constants of the respective data lines DL1 to DLk through the dummy data lines DML1 to DMLk by making physical property of the dummy data lines DML1 to DMLk maximally similar to that of the data lines DL1 to DLk.

Meanwhile, the gate driver 106 sequentially outputs scan signals S[1:n], that are pulse signals, through gate lines GL1 to GLn. Therefore, the pixels 102 are selected and activated in a row unit. The pixels 102 are driven and emitted by data current only in a state where they are activated by the scan signals S[1:n].

The data driver 107 sequentially receives data signals DATA configured of a plurality of bits in a bit unit. When the data driver 107 receives all bits corresponding to the pixels in a row unit, it latches the bits and then simultaneously outputs them in parallel. At this time, the pixels 102 cannot be driven by directly responding to the signals in a digital form, such that they are converted into data currents in an analog form through the digital-analog converter 108. The data currents generated from the digital-analog converters 108 are applied to the respective pixel driving buffers 109.

The pixel driving buffer 109 first measures time constants of the dummy data lines DML1 to DMLk. This is performed by a method of sensing current attenuated by the time constants from the dummy data lines DML1 to DMLk. The respective pixel driving buffers 109 add the sensed current to data current to drive the corresponding data lines DL1 to DLk, thereby compensating for the data current. The respective pixel driving buffers 109 drive the pixels 102 connected to the corresponding data lines DL1 to DLk with the compensated data current. In other words, the physical properties of the data lines and the dummy data lines adjacent to each other, while forming a pair, may be considered to be almost similar. As a result, the time constants of the dummy data lines are measured to indirectly measure the time constants of the data lines adjacent thereto and the data current to drive the data lines are previously compensated according to the time constants. Meanwhile, before driving the pixels 102 in a first row, the pixel driving buffer 109 senses the time constants of all of the dummy data lines DML1 to DMLk to compensate for the data current, thereby driving all of the pixels 102 with the compensated data current.

As described above, the organic electroluminescence display according to a first embodiment indirectly measures the time constants of the respective data lines DL1 to DLk through the dummy data lines DML1 to DMLk adjacently arranged corresponding to the respective data lines DL1 to DLk and previously compensates for the data current to be transmitted through the data lines DL1 to DLk according to the time constants.

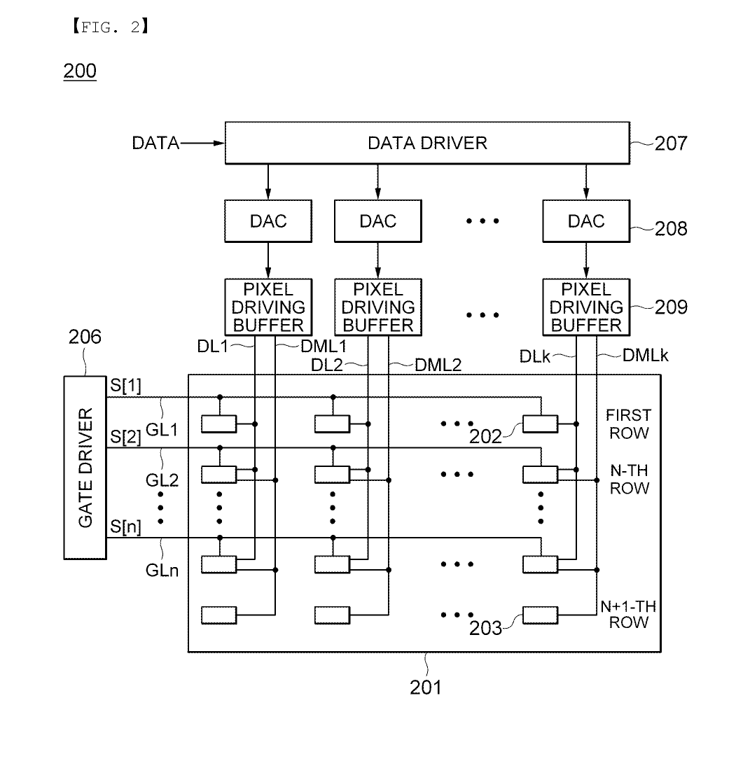

FIG. 2 is a block diagram showing a configuration of an organic electroluminescence display according to a second embodiment of the present invention.

The second embodiment has many portions overlapping with the first embodiment in view of a basic constitution. Therefore, the second embodiment will be described based on characteristic portions distinguished from the first embodiment.

Referring to FIG. 2, an organic electroluminescence display 200 includes a display panel 201, a gate driver 206, a data driver 207, a plurality of digital-analog converter (DAC)s 208, and a plurality of pixel driving buffers 209.

First, on the display panel 201, pixels 202 are arranged in a matrix format and dummy pixels 203 constituting at least one row are arranged. In other words, the pixels 202 in first to N-th rows are pixels actually driven by data current to be emitted, whereas the dummy pixels 203 in an N+1-th row are pixels not emitted regardless of the data current. The dummy pixels 203 are added in order to only measure the time constants of the dummy data lines DML1 to DMLk.

More specifically, the pixels 202 in the first to N-th rows are each connected to the data lines DL1 to DLk in a column unit, and the pixels 202 in a second to N-th rows and the dummy pixels 203 in the N+1-th row are each connected to the dummy data lines DML1 to DMLk in a column unit. In other words, the pixels 202 in at least one row are not connected to the dummy data lines DML1 to DMLk and rows configured by the dummy pixels 203 are added by the number of rows to which the dummy data lines DML1 to DMLk are not connected. As described above, the pixels 202 and 203 in the second to N+1-th rows each adjacent to the pixels 202 in the first to N-th rows connected to the data lines DL1 to DLk are connected to the dummy data lines DML1 to DMLk, thereby providing physical environment similar to the data lines DL1 to DLk to the dummy data lines DML1 to DMLk. Therefore, the time constants of the dummy data lines DML1 to DMLk measured in the second embodiment may be almost similar to the time constants of the data lines DL1 to DLk as compared to the first embodiment. When the pixels 202 in the first and second rows are connected to the data lines DL1 to DLk but not connected to the dummy data lines DML1 to DMLk, the dummy pixels 203 in the N+2-th row should be additionally arranged in addition to those in the N+1-th row as shown in FIG. 2 to be connected to the dummy data lines DML1 to DMLk, thereby making it possible to provide physical environment similar to that of the data lines DL1 to DLk.

Meanwhile, when the gate driver 206 output the scan signal S[1] through a gate line GL1, the pixels 202 in the first row are activated. During the activation period, the pixel driving buffers 209 senses currents of the dummy data lines DML1 to DMLk attenuated by the time constants in order to sense the time constants. The data currents are compensated by adding the sensed currents to the data currents and the respective corresponding data lines DL1 to DLk are driven by the compensated currents. Generally, the gate driver 206 is sequentially activated from the first row to the N-th row. Before driving the pixels 202 in the first row, the pixel driving buffer 209 senses all of the time constants of the dummy data lines DML1 to DMLk to compensate for the data current to be applied in driving the data lines DL1 to DLk. Therefore, the data currents may be compensated during the period where the pixels 202 in the first row are activated by the scan signals, before the pixels 202 in the first row are activated or when the display panel is power-on.

Meanwhile, even though the dummy row configured of the dummy pixels 203 is shown as the N+1-th row only in FIG. 2 by way of example, it is not limited thereto but several dummy rows may also be added. When the dummy data lines DML1 to DMLk are connected from a K+1th row, the dummy data lines DML1 to DMLk should be connected up to an N+K-th row in order to provide physical environment similar to the data lines DL1 to DLk. For example, when the dummy data lines DML1 to DMLk are connected from a fourth row, they should be connected up to an N+3-th row. At this time, the dummy rows in the N+1-th row, the N+2-th row, and the N+3-th row, that is, three dummy rows, are added. As shown in FIG. 2, when the dummy data lines DML1 to DMLk are connected from the second row to the N+1-th row, the aforementioned K value becomes 1 and the number of added dummy rows also becomes 1.

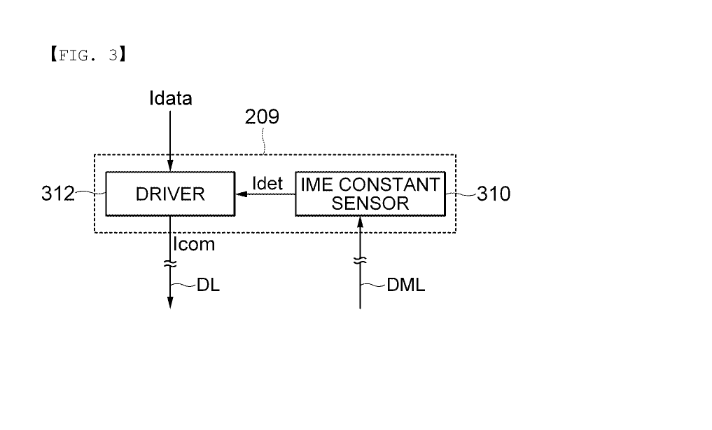

FIG. 3 is a block diagram showing a configuration of a pixel driving buffer.

Referring to FIG. 3, the pixel driving buffer 209 includes a time constant sensor 310 and a driver 312.

First, the time constant sensor 310 senses current of the dummy data line DML in order to sense the time constants. The sensed current is current attenuated by the time constants, such that the time constants can be appreciated thereby. Meanwhile, the driver 312 receives data current Idata converted into an analog form by the digital-analog converter 208 to add sensed current Idet into the data current Idata, thereby generating compensation current Icom. The driver 312 drives pixels connected to the corresponding data line DL by the compensation current Icom. Therefore, it is possible to reduce delay and attenuation of the data current by the data line DL.

As described above, the organic electroluminescence display according to a second embodiment indirectly measures the time constants of the respective data lines DL1 to DLk through the dummy data lines DML1 to DMLk adjacently arranged corresponding to the respective data lines DL1 to DLk and connected to the pixels 202 and the dummy pixels 203 similar to the data lines DL1 to DLk and previously compensates for the data current to drive the data lines DL1 to DLk according to the time constants.

The exemplary embodiments of the present invention sense parasitic components existing in the respective data lines and previously compensate for the data currents that is to drive the data lines according to the sensed parasitic components to drive the data lines according to the compensated data currents, thereby making it possible to reduce operation deviation between the pixels that may be generated according to parasitic components of the data lines.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An organic electroluminescence display, comprising:
a plurality of pixels arranged in a matrix format on a display panel;
a plurality of first and second data lines repeatedly arranged in a column direction on the display panel, while forming a pair; and
a plurality of pixel driving buffers sensing time constants of the respective second data lines and compensating for each of data currents by the number of sensed time constants to drive pixels connected to the corresponding first data lines with the compensated data currents.

2. The organic electroluminescence display according to claim 1, wherein among the first and second data lines, the first data lines are electrically connected to the pixels and the second data lines are not connected to the pixels.

3. The organic electroluminescence display according to claim 1, wherein before driving the pixels in a first row, the pixel driving buffers sense the time constants of the second data lines to compensate for the data currents.

4. The organic electroluminescence display according to claim 1, wherein the pixel driving buffer includes:
a time constant sensor sensing time constants of the respective second data lines; and
a driver receiving the data current to compensate for the data current by the number of sensed time constants and drive the pixels by the compensated data current.

5. The organic electroluminescence display according to claim 1, further comprising a gate driver sequentially activating the pixels in a row unit.

6. The organic electroluminescence display according to claim 5, further comprising a data driver outputting the data signals in order to drive the pixels in the activated rows.

7. An organic electroluminescence display, comprising:
a display panel;
a plurality of pixels arranged in a matrix format on the display panel;
a gate driver sequentially activating the pixels in a row unit through gate lines connected to each of the pixels in the row unit;
a data driver outputting data current in order to drive the pixels in the activated row;
a plurality of data lines arranged in a column direction on the display panel, each being connected to the pixels in a column unit;
a plurality of dummy data lines arranged corresponding to the respective data lines; and
a plurality of pixel driving buffers sensing time constants of the respective dummy data lines and compensating for each of data currents according to the number of sensed time constants to drive the pixels through the corresponding data lines.

8. The organic electroluminescence display according to claim 7, wherein among the data lines and the dummy data lines, only the data lines are electrically connected to the pixels.

9. The organic electroluminescence display according to claim 7, wherein the pixel driving buffer includes:
a time constant sensor sensing current of the dummy data lines in order to sense time constants; and
a driver generating a compensation current by adding the sensed current to the data current and driving the pixels connected to the corresponding data lines with the compensation current.

10. An organic electroluminescence display, comprising:
a plurality of pixels arranged in a matrix format on a display panel and configured of first to N+K-th rows;
a plurality of first data lines connected to pixels each in the same column of pixels in the first to N-th rows;
a plurality of second data lines connected to pixels each in the same column of pixels in the k+1-th to N+K-th rows; and
a plurality of pixel driving buffers sensing time constants of the second data lines and compensating for data currents according to the number of sensed time constants to drive the respective corresponding first data lines with the compensated data currents (N and k are natural numbers).

11. The organic electroluminescence display according to claim 10, wherein the pixels in the k+1-th to N+K-th rows are dummy pixels that are not driven.

12. The organic electroluminescence display according to claim 10, wherein the respective pixel driving buffers include:
a time constant sensor sensing time constants of the second data lines; and
a driver receiving the data current to compensate for the data current by the number of sensed time constants and drive the pixels connected to the corresponding first data line by the compensated data current.

13. The organic electroluminescence display according to claim 10, further comprising a gate driver sequentially activating the pixels in the first to N-th rows in a row unit.

14. The organic electroluminescence display according to claim 13, further comprising a data driver outputting the data currents in order to drive the pixels in the activated rows.

15. An organic electroluminescence display, comprising:
a display panel;
a plurality of data lines and gate lines arranged on the display panel orthogonally to each other;
a plurality of dummy data lines arranged in parallel, each corresponding to the data lines;
a plurality of first pixels configuring at least one row and each connected to the data lines;
a plurality of second pixels configuring at least one row and connected in common to the data lines and the dummy data lines;
a plurality of third pixels configuring at least one row and each connected the dummy data lines; and
a plurality of pixel driving buffers sensing time constants of the respective dummy data lines and compensating for data currents according to the number of sensed time constants to drive pixels each connected to the corresponding data lines.

16. The organic electroluminescence display according to claim 15, wherein the third pixel is a dummy pixel that is not driven regardless of the data current.

17. The organic electroluminescence display according to claim 15, wherein the number of first pixels connected to the data lines and the number of third pixels connected to the dummy data lines corresponding thereto are the same.

18. The organic electroluminescence display according to claim 15, wherein the pixel driving buffer senses the number of time constants of the dummy data lines during a period where the only the first pixels are activated.

19. The organic electroluminescence display according to claim 15, wherein before driving the first row, the pixel driving buffers sense the number of time constants of the dummy data lines to compensate for the data currents.

20. The organic electroluminescence display according to claim 15, wherein the respective pixel driving buffers include:
a time constant sensor sensing current of the dummy data lines in order to sense time constants of the dummy data lines; and
a driver generating a compensation current by adding the current sensed by the time constant sensor to the data currents and driving the pixels connected to the corresponding data lines by the compensation current.

21. The organic electroluminescence display according to claim 15, further comprising a gate driver sequentially activating the pixels in a row unit.

22. The organic electroluminescence display according to claim 21, further comprising a data driver outputting the data currents in order to drive the pixels in the activated rows.
